(19) United States
(12) Patent Application Publication
(10) Pub. No.: US 2009/0086764 A1
(43) Pub. Date: Apr. 2, 2009

(54) System and method for time synchronization on network

(75) Inventors: Seung-woo Lee, Daejeon-si (KR); Bhum-cheol Lee, Daejeon-si (KR); Young-ho Park, Daejeon-si (KR); Jung-hee Lee, Daejeon-si (KR); Dae-geun Park, Daejeon-si (KR); Hyun-yong Hwang, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Telecommunications Research Institute

(21) Appl. No.: 12/156,163

(22) Filed: May 29, 2008

(30) Foreign Application Priority Data
Sep. 27, 2007 (KR) 10-2007-0097405

(51) Int. Cl. H04J 3/06

(52) U.S. Cl. 370/503

(57) ABSTRACT

A system and method for time synchronization on a network is provided. According to the system and method for time synchronization, a slave clock device does not continuously receive a time synchronization message periodically transferred from a master clock device and thus does not correct its time upon all such occasions. Rather, the slave clock device requests time information from the master clock device only when the slave clock device needs to correct its time, and receives a time synchronization message transferred from the master clock device and compensates for its time deviation only while the slave clock device is activated, thereby reducing its power consumption and amount of computation.

### CROSS REFERENCE TO RELATED APPLICATIONS

This application claims priority from Korean Patent Application No. 10-2007-0097405, filed on Sep. 27, 2007, the disclosure of which is incorporated herein in its entirety by reference.

### BACKGROUND OF THE INVENTION

1. Field of the Invention

The present invention relates to a system and method for time synchronization on a network, and more particularly, to technology for time synchronization between at least two devices or systems distributed on a network.

This work was supported by the IT R&D program of Ministry of Information and Communication (MIC)/Institute for Information Technology Advancement (IITA) [2007-S-012-01, Multimedia Convergence Network on Chip Technology Development].

2. Description of the Related Art

In general, a time synchronization protocol is required for time synchronization between at least two devices or systems distributed in a packet-switched network. A device or system providing a reference time for time synchronization is set as a master, a device or system to be time-synchronized with the master is set as a slave, and then the master and the slave exchange messages including time information to achieve time synchronization between the master and the slave.

Among conventional protocols for time synchronization between a master and a slave connected via a network, a Network Time Protocol (NTP) has been used. The NTP is still widely used for time synchronization in a Local Area Network (LAN), a Wide Area Network (WAN), and so on. The NTP achieves time synchronization among computers connected via a network using a Coordinated Universal Time (UTC) that is the international time standard. The NTP does not require additional hardware and thus is low-priced. The accuracy of the NTP is several microseconds to several tens of microseconds in a normal Internet environment.

However, circuit-switched networks are being replaced by packet-switched networks employing low-priced Ethernet technology, and real time streaming service is demanded. Thus, a time-synchronization protocol with high accuracy is required to replace the NTP. To this end, Institute of Electrical and Electronics Engineers (IEEE) has developed and standardized a Precision Time Protocol (PTP) having improved accuracy.

FIG. 1 shows a time synchronization process between a master and a slave according to the PTP. According to the PTP, similar to the NTP, a master clock device and a slave clock device exchange time information and messages related to the time information to determine an offset between the master clock and the slave clock and a propagation delay time taken for a message transferred via a network, and the clock, i.e., time, of the slave clock device is synchronized with the clock, i.e., time, of the master clock device.

First, to determine an offset, a master clock device 100 periodically transfers a time synchronization message SYNC to a slave clock device 200. Here, the master clock device 100 accurately measures, using a time stamp, a time t1 at which the time synchronization message SYNC is transferred. The slave clock device 200 receives the time synchronization message SYNC transferred from the master clock device 100 and measures, using a time stamp, an accurate time t2 at which the time synchronization message SYNC is received.

Subsequently, the master clock device 100 transfers a follow-up message FOLLOW_UP including information on the time t1 at which the time synchronization message SYNC is transferred, to the slave clock device 200. The slave clock device 200 receives the follow-up message FOLLOW_UP transferred from the master clock device 100, and may calculate an offset for time correction using information on the time t1 at which the time synchronization message SYNC is transferred and the time t2 at which the time synchronization message SYNC is received.

While the time synchronization message SYNC and the follow-up message FOLLOW_UP are transferred from the master clock device 100 to the slave clock device 200 via the network, a propagation delay time may occur, and an error in a measured time may be caused by clock frequency drift of the slave clock device 200. Thus, it is necessary to compensate for these factors.

First, to measure the propagation delay time of a message on a network, the slave clock device 200 transfers a delay request message DELAY_REQ to the master clock device 100, and accurately measures a time t3 at which the delay request message DELAY_REQ is transferred. The master clock device 100 receiving the delay request message DELAY_REQ from the slave clock device 200 accurately measures a time t4 at which the delay request message DELAY_REQ is received, and transfers a delay response message DELAY_RESP including information on the time t4 to the slave clock device 200.

Consequently, the slave clock device 200 has the information on the times t3 and t4 as well as the information on the times t1 and t2, and determines an offset O and a propagation delay time D using Equations (1) to (4) on the basis of the information on the four times t1 to t4.

D+O=t2−t1 Equation (1)

D−O=t4−t3 Equation (2)

D=((t2−t1)+(t4−t3))/2 Equation (3)

O=((t2−t1)−(t4−t3))/2 Equation (4)

Here, it is assumed that a propagation delay time taken for the master clock device 100 to transfer a message to the slave clock device 200 is symmetrically the same as a propagation delay time taken for the slave clock device 200 to transfer a message to the master clock device 100.

The master clock device 100 periodically transfers the time synchronization message SYNC, and the slave clock device 200 compensates for its time deviation using the offset O calculated by Equations (1) to (4).

According to the PTP, similar to the NTP, a master clock device and a slave clock device exchange messages including time information to achieve time synchronization. However, the PTP has a difference from the NTP in that a master clock device periodically transfers a time synchronization message SYNC and a follow-up message FOLLOW_UP to a slave clock device to increase accuracy, and additional hardware is used to measure a time at which a message is transferred or received in a more accurate clock value.

The above-described conventional time-synchronization method has problems as described below. First, a master clock device periodically transfers a time synchronization message SYNC to a slave clock device, the slave clock device continuously receives the periodic time synchronization message and corrects its time, and thus a large amount of power is consumed for receiving the message and performing computation.

In addition, a slave clock device not requiring high accuracy of a clock and required to reduce power consumption, does not need to receive the time synchronization messages more than necessary in order to minimize the amount of computation for time synchronization. Furthermore, the slave clock device does not need to request time information from the master clock device so frequently to calculate a propagation delay time.

The conventional method whereby a master clock device and a slave clock device exchange messages according to a determined time period, consumes a large amount of power and performs a large amount of computation. Consequently, the inventor of the present invention has researched technology that allows a slave clock device to request time information from a master clock device only when the slave clock device needs to correct its time and to receive a time synchronization message transferred from the master clock device and compensate for its time deviation only while the slave clock device is activated, and thereby reduces the power consumption and the amount of computation of the slave clock device.

### SUMMARY OF THE INVENTION

The present invention provides a system and method for time synchronization on a network that allows a slave clock device to request time information from a master clock device only when the slave clock device needs to correct its time and to receive a time synchronization message transferred from the master clock device and compensate for its time deviation only when the slave clock device is activated, thereby reducing the power consumption and the amount of computation of the slave clock device.

Additional aspects of the invention will be set forth in the description which follows, and in part will be apparent from the description, or may be learned by practice of the invention.

The present invention discloses a system for time synchronization on a network, including: a master clock device configured to periodically transfer a time synchronization signal including information on a first time t1 at which the time synchronization signal is transferred, and to transfer a time information response signal including information on a fourth time t4 at which a time information request signal is received, in response to the time information request signal from the slave clock device; and a slave clock device configured to be periodically or aperiodically activated to receive the time synchronization signal only when changing the slave clock device's clock, store information on a second time t2 at which the time synchronization signal is received, transfer the time information request signal to the master clock device, receive the time information response signal from the master clock device, store information on a third time t3 at which the time information request signal is transferred, and perform time synchronization with the master clock device using the information on the first to fourth times t1 to t4.

The present invention also discloses a method for time synchronization on a network which has a master clock device and a slave clock device, including: activating the slave clock device when the slave clock device has to correct a time of the slave clock device; receiving from the master clock device a time synchronization signal including information on a first time t1 at which the time synchronization signal is transferred; storing, in the slave clock device, information on a second time t2 at which the time synchronization signal is received; transferring a time information request signal to the master clock device, and storing, in the slave clock device, information on a third time t3 at which the time information request signal is transferred; transferring to the slave clock device a time information response signal including information on a fourth time t4 at which the time information request signal is received; and performing time synchronization with the master clock device using the information on the first to fourth times t1 to t4.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 shows a time synchronization process between a master and a slave according to a Precision Time Protocol (PTP).

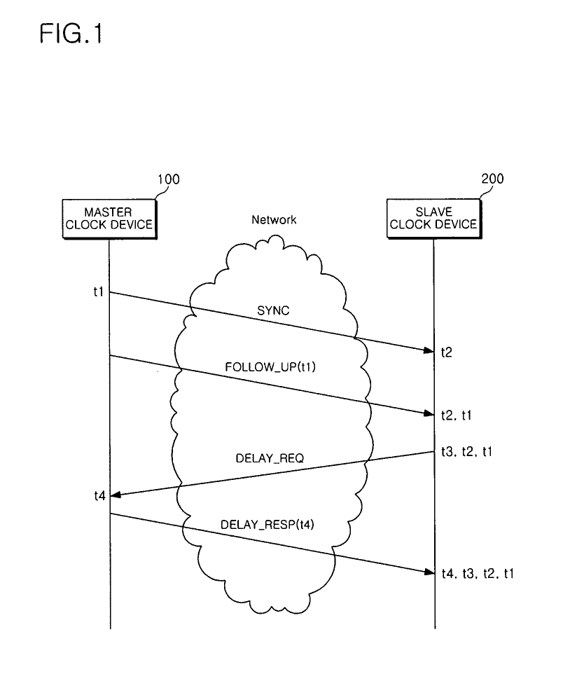

FIG. 2 shows a formation of a time synchronization system on a network according to an exemplary embodiment of the present invention.

FIG. 3 is a signal flowchart of a time synchronization system on a network according to an exemplary embodiment of the present invention.

FIG. 4 shows an example of applying a time synchronization system on a network according to an exemplary embodiment of the present invention to time-synchronize a slave clock device.

FIG. 5 is a flowchart showing a time synchronization method on a network according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Like reference numerals in the drawings denote like elements.

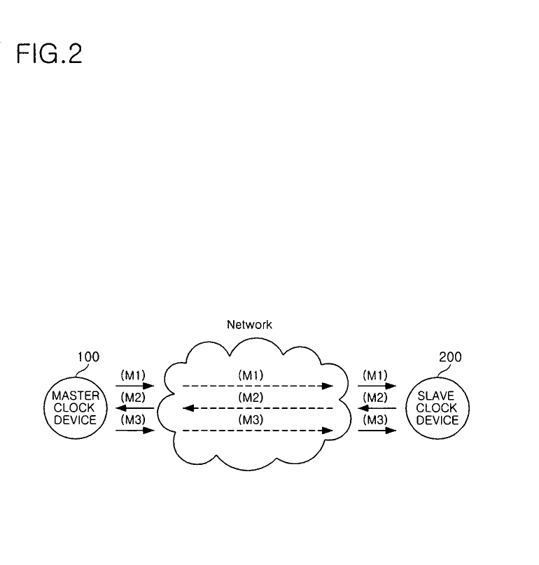

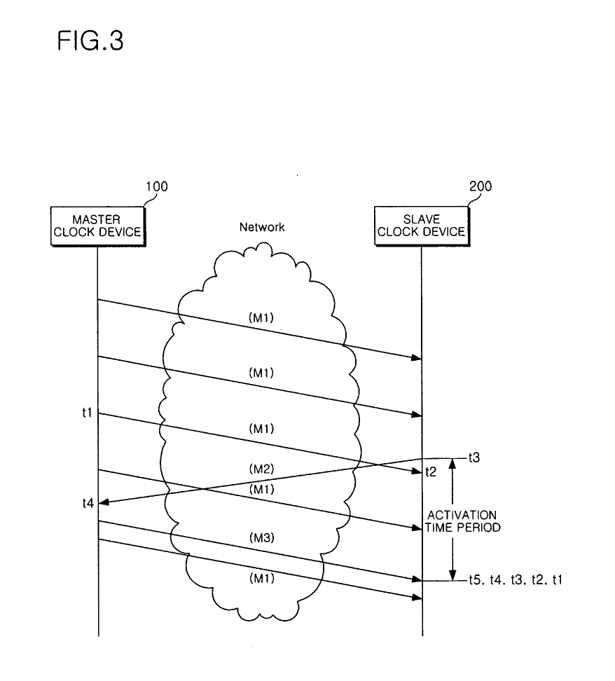

FIG. 2 shows a formation of a time synchronization system on a network according to an exemplary embodiment of the present invention, and FIG. 3 is a signal flowchart of the time synchronization system on a network according to an exemplary embodiment of the present invention. As illustrated in the drawings, the time synchronization system on a network includes a master clock device 100 and a slave clock device 200.

The master clock device 100 provides a reference time for time synchronization, and the slave clock device 200 is time-synchronized with the master clock device 100. For example, the master clock device 100 may be a time server that provides a Primary Reference Clock (PRC) or a Grand Master (GM) clock as a reference time, and the slave clock device 200 may be a switching device, a routing device or a communication terminal device connected with the time server via a network.

The master clock device 100 periodically transfers a time synchronization signal M1 including information on a first time t1 at which the time synchronization signal M1 is transferred, and transfers a time information response signal M3 including information on a fourth time t4 at which a time information request signal M2 is received from the slave clock device 200 in response to the time information request signal M2.

The slave clock device 200 is activated to receive the time synchronization signal M1 only when it needs to correct its time, and stores information on a second time t2 at which the time synchronization signal M1 is received. In addition, the slave clock device 200 transfers the time information request signal M2 to the master clock device 100, receives the time information response signal M3 from the master clock device 100, stores information on a third time t3 at which the time information request signal M2 is transferred, and performs time-synchronization with the master clock device 100 using the information on the first to fourth times t1 to t4.

More specifically, the master clock device 100 periodically transfers the time synchronization signal M1 including information on the first time t1 at which the time synchronization signal M1 is transferred. When the slave clock device 200 does not need to correct its time, it is inactivated and does not receive the time synchronization signal M1 transferred from the master clock device 100.

When the slave clock device 200 needs to correct its time, it is activated, receives the time synchronization signal M1 transferred from the master clock device 100, measures the second time t2 at which the time synchronization signal M1 is received, and stores information on the second time t2. Here, the slave clock device 200 may be periodically or aperiodically activated.

In addition, when the slave clock device 200 is activated, it transfers the time information request signal M2 to the master clock device 100, measures the third time t3 at which the time information request signal is transferred, and stores information on the third time t3. Here, any operation between reception of the time synchronization signal M1 and transfer of the time information request signal M2 may be performed first.

Then, the master clock device 100 receives the time information request signal M2 from the slave clock device 200, measures the fourth time t4 at which the time information request signal M2 is received, and transfers the time information response signal M3 including information on the fourth time t4 to the slave clock device.

The slave clock device 200 receives the time information response signal M3 from the master clock device 100, and performs time synchronization with the master clock device 100 using the information on the first to fourth times t1 to t4.

Here, as shown in Equation (5) below, a first value (D+O) obtained by adding a propagation delay time D and an offset O is equal to a value (t2−t1) obtained by subtracting the first time t1 at which the time synchronization signal M1 is transferred from the second time t2 at which the time synchronization signal M1 is received. And, as shown in Equation (6) below, a second value (D−O) obtained by subtracting the offset O from the propagation delay time D is equal to a value (t4−t3) obtained by subtracting the third time t3 at which the time information request signal M2 is transferred from the fourth time t4 at which the time information request signal M2 is received. Therefore, the slave clock device 200 can be time-synchronized with the master clock device 100 using Equation (8) below.

D+O=t2−t1 Equation (5)

D−O=t4−t3 Equation (6)

D=((t2−t1)+(t4−t3))/2 Equation (7)

O=((t2−t1)−(t4−t3))/2 Equation (8)

More specifically, as shown in Equation (8), the slave clock device 200 subtracts the second value (D−O) of Equation (6) from the first value (D+O) of Equation (5) and divides both sides of the result by 2 to calculate the offset O=((t2−t1)−(t4−t3))/2. The slave clock device 200 reflects the offset O in its time to perform time synchronization with the master clock device 100.

In this way, in the time synchronization system on a network according to an exemplary embodiment of the present invention, the slave clock device 200 does not continuously receive a time synchronization message periodically transferred from the master clock device 100 and thus does not correct its time upon all such occasions. Rather, the slave clock device 200 requests time information from the master clock device 100 only when it needs to correct its time, and receives a time synchronization message transferred from the master clock device 100 and compensates for its time deviation only while it is activated, thereby reducing its power consumption and amount of computation. Consequently, it is possible to achieve the above-mentioned object of the present invention.

Meanwhile, the slave clock device 200 of the time synchronization system on a network according to an exemplary embodiment of the present invention may add the first value (D+O) of Equation (5) and the second value (D−O) of Equation (6) and divide both sides of the result by 2 to calculate the propagation delay time D=((t2−t1)+(t4−t3))/2 as expressed by Equation (7).

The propagation delay time is a difference value between a time at which a time synchronization signal enters a network and a time at which the time synchronization signal comes out of the network in a process of transferring the time synchronization signal from the master clock device 100 to the slave clock device 200. When a slave clock device is frequency-synchronized with a master clock device using a periodic time interval of time synchronization signals, a difference between an input time and an output time, that is, a time taken for the time synchronization signals to pass through a network may be the propagation delay time. From the propagation delay time, it is possible to obtain the degree of propagation delay through the network.

Meanwhile, an activation time period of the slave clock device 200 is from the third time t3 at which the time information request signal M2 is transferred to a fifth time t5 at which the slave clock device 200 receives the time information response signal M3. Only for this duration is the slave clock device 200 activated to receive the time synchronization signal transferred from the master clock device 100 and compensate for its time deviation, thereby reducing its power consumption and amount of computation. Consequently, it is possible to achieve the above-mentioned object of the present invention.

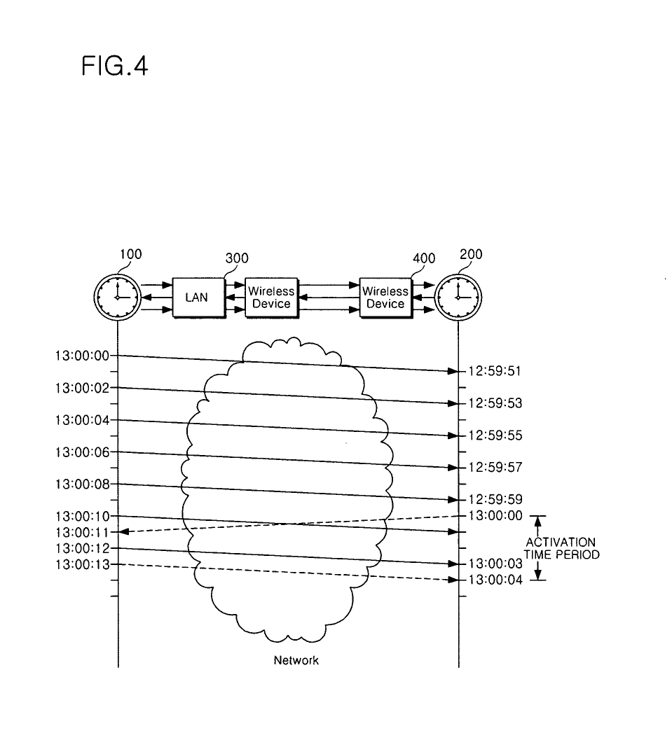

FIG. 4 shows an example of applying a time synchronization system on a network according to an exemplary embodiment of the present invention to time-synchronize a slave clock device. Referring to the drawing, a master clock device 100 provides a reference time, and is connected with a slave clock device 200 through a wired network device 300, such as a Local Area Network (LAN) switch, etc., and a wireless network device 400, such as ZigBee, etc. The reference time may be a PRC or a GM clock.

For example, let it be assumed that the master clock device 100 is a time server receiving a reference time measured by a Global Positioning System (GPS) (not shown in the drawing) and periodically transferring a time synchronization signal to a network, and the slave clock device 200 is a wall clock connected with the time server through the wired device 300 and the wireless device 400.

The time server, which is the master clock device 100 receiving the reference time from the GPS (not shown), periodically outputs to the network a time synchronization signal including information on a time at which the time synchronization signal is transferred to slave clock devices on the network.

The wall clock, which is the slave clock device 200, is usually inactivated and does not receive the time synchronization signal transferred from the time server. Only when the wall clock needs to correct its time, is it activated and receives the time synchronization signal. Here, the wall clock may be periodically or aperiodically activated.

Activation of the wall clock begins when the wall clock transfers a time information request signal to the time server. The time server receiving the time information request signal from the wall clock through the wired network device 300 and the wireless network device 400, measures a time at which the time information request signal is received and transfers a time information response signal including information on the measured time to the wall clock. The wall clock adjusts its time using the time synchronization signal received from the time server and time information collected or measured by the wall clock to time-synchronize with the time server.

For example, assuming that the time server transfers the time synchronization signal to the network every two seconds, the current time of the time server is 13:00:00, the wall clock time-synchronizes its clock with the time server every hour, and the current time of the wall clock is 12:59:50, a time difference between the time server and the wall clock is ten seconds. Also, let it be assumed that a time, i.e., a propagation delay time, taken for a signal transferred from the time server to the wall clock is one second, and the time taken for a signal transferred from the time server to the wall clock and a time taken for a signal transferred from the wall clock to the time server are the same and symmetrical with each other.

Then, the time server transfers the time synchronization signal to the network every two seconds, such as 13:00:00, 13:00:02, 13:00:04, etc. Each time synchronization signal includes information on a current time of the time server, i.e., a time at which the time synchronization signal is transferred.

The wall clock is usually inactivated, but is activated every hour that is its set activation time to transfer the time information request signal to the time server and receives the time synchronization signal from the time server only during an activation time period.

Therefore, the wall clock transfers the time information request signal when its time is 13:00:00, and stores a time t3, i.e., 13:00:00, at which the time information request signal is transferred. The time server receives the time information request signal after one second that is a propagation delay time, and measures a time t4 at which the time information request signal is received. Since the time difference between the time server and the wall clock is ten seconds, and the propagation delay time is one second, the time t4 at which the time server receives the time information request signal is 13:00:11.

After internal signal processing, for example, after two seconds, the time server includes the time t4, i.e., 13:00:11, at which the time information request signal is received, in a time information response signal and transfers the time information response signal. After one second that is the propagation delay time, the time information response signal is received by the wall clock. Here, time information that the wall clock has is the time t3, i.e., 13:00:00, at which the time information request signal is transferred and the time t4, i.e., 13:00:11, at which the time information request signal is received, included in the time information response signal.

In addition, during the activation time period in which the time information request signal and the time information response signal are exchanged, a time t2, at which the wall clock receives the latest time synchronization signal from the time server, is 13:00:03, and a time t1, at which the latest time synchronization signal is transferred, included in the latest time synchronization signal is 13:00:12 because a time difference between the time server and the wall clock is ten seconds, and the propagation delay time is one second.

In other words, the wall clock obtains the time information t1=13:00:12, t2=13:00:03, t3=13:00:00 and t4=13:00:11. An offset O is calculated from the time information using Equation (8) above: O=((t2−t1)−(t4−t3))/2=((13:00:03)−(13:00:12)−(13:00:11−13:00:00))/2=(−9 seconds−11 seconds)/2=−10 seconds.

This means that the wall clock is ten seconds behind the time server. Therefore, assuming that an internal process time of the wall clock is two seconds, the calculated offset O is reflected in the time of the wall clock at 13:00:05, which is corrected into 13:00:15. Through this process, the wall clock is time-synchronized with the time server. After the time synchronization process, the wall clock finishes the activation time period and is inactivated again. Thus, the wall clock does not receive the time synchronization signal transferred from the time server and operates as a local clock by itself.

Meanwhile, the wall clock may be activated only when its power is turned on or reset to transfer the time information request signal to the time server, receive the time information response signal from the time server, and receive the time synchronization signal from the time server. In other words, the wall clock may be implemented to be time-synchronized with the time server only when its power is turned on or reset.

Meanwhile, when the propagation delay time is so small as to be negligible, D is equal to 0 in Equation (5) above, and thus O is equal to (t2−t1). Since only the time t1 at which the time server transfers the time synchronization signal and the time t2 at which the wall clock receives the time synchronization signal are needed, the wall clock can be time-synchronized with the time server using the time synchronization signal alone.

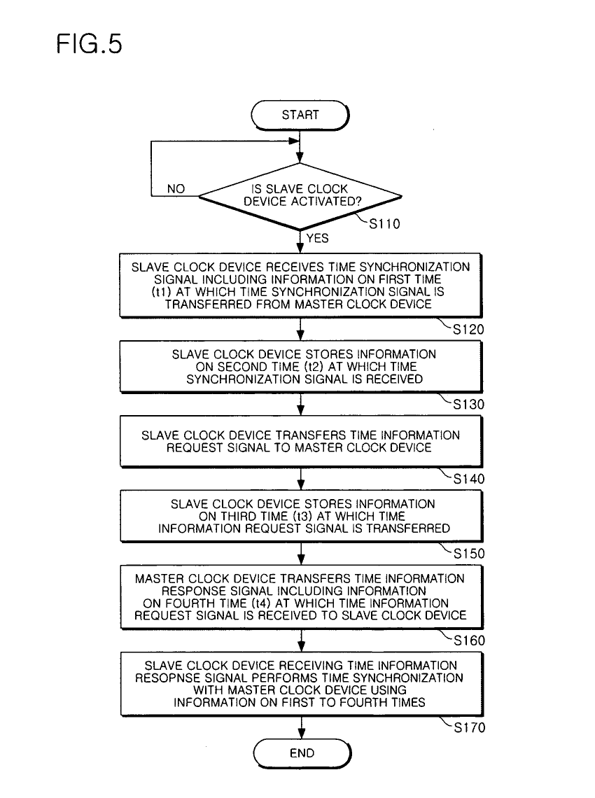

A time synchronization method of the time synchronization system on a network having the above described constitution according to an exemplary embodiment of the present invention will be described below in brief with reference to FIG. 5. FIG. 5 is a flowchart showing a time synchronization method on a network according to an exemplary embodiment of the present invention.

A time server, i.e., a master clock device, providing a reference time periodically transfers a time synchronization signal to a network, and a slave clock device is usually inactivated and does not receive the time synchronization signal transferred from the time server. Only when the slave clock device needs to correct its time, is it activated (step 110).

When the slave clock device is activated, it receives the time synchronization signal including information on a first time t1 at which the time synchronization signal is transferred from the master clock device (step 120), and stores information on a second time t2 at which the slave clock device receives the time synchronization signal (step 130).

Subsequently, the slave clock device transfers a time information request signal to the master clock device (step 140), and stores information on a third time t3 at which the time information request signal is transferred (step 150).

Then, the master clock device receiving the time information request signal transfers a time information response signal including information on a fourth time t4 at which the time information request signal is received to the slave clock device (step 160), and the slave clock device receiving the time information response signal performs time synchronization with the master clock device using the information on the first to fourth times t1 to t4 (step 170).

Here, as shown in Equation (5) above, a first value (D+O) obtained by adding a propagation delay time D and an offset O is equal to a value (t2−t1) obtained by subtracting the first time t1 at which the time synchronization signal is transferred from the second time t2 at which the time synchronization signal is received. And, as shown in Equation (6) above, a second value (D−O) obtained by subtracting the offset O from the propagation delay time D is equal to a value (t4−t3) obtained by subtracting the third time t3 at which the time information request signal is transferred from the fourth time t4 at which the time information request signal is received. Therefore, the slave clock device can be time-synchronized with the master clock device using Equation (8) above.

More specifically, as shown in Equation (8), the slave clock device subtracts the second value (D−O) of Equation (6) from the first value (D+O) of Equation (5) and divides both sides of the result by 2 to calculate the offset O=((t2−t1)−(t4−t3))/2. The slave clock device reflects the offset O in its time to perform time synchronization with the master clock device.

As apparent from the above description, a slave clock device does not continuously receive a time synchronization message periodically transferred from a master clock device and thus does not correct its time upon all such occasions. Rather, according to the present invention, the slave clock device requests time information from the master clock device only when the slave clock device needs to correct its time, and receives a time synchronization message transferred from the master clock device and compensates for its time deviation only while the slave clock device is activated, thereby reducing its power consumption and amount of computation. As a result, it is possible to achieve the above-mentioned object of the present invention.

The present invention can be effectively used in the field of synchronization technology for time synchronization between at least two devices or systems.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A system for time synchronization on a network, comprising:
a master clock device configured to periodically transfer a time synchronization signal including information on a first time t1 at which the time synchronization signal is transferred, and to transfer a time information response signal including information on a fourth time t4 at which a time information request signal is received, in response to the time information request signal from the slave clock device; and
a slave clock device configured to be periodically or aperiodically activated to receive the time synchronization signal only when changing the slave clock device's clock, store information on a second time t2 at which the time synchronization signal is received, transfer the time information request signal to the master clock device, receive the time information response signal from the master clock device, store information on a third time t3 at which the time information request signal is transferred, and perform time synchronization with the master clock device using the information on the first to fourth times t1 to t4.

2. The system of claim 1, wherein the slave clock device sets a first value (D+O) obtained by adding a propagation delay time D and an offset O to be equal to a value (t2−t1) obtained by subtracting the first time t1 from the second time t2, sets a second value (D−O) obtained by subtracting the offset O from the propagation delay time D to be equal to a value (t4−t3) obtained by subtracting the third time t3 from the fourth time t4, calculates the offset O=((t2−t1)−(t4−t3))/2 by subtracting the second value (D−O) from the first value (D+O) and dividing both sides of the result by 2, and incorporates the offset O into a time of the slave clock device to perform time synchronization with the master clock device.

3. The system of claim 1, wherein the slave clock device sets a first value (D+O) obtained by adding a propagation delay time D and an offset O to be equal to a value (t2−t1) obtained by subtracting the first time t1 from the second time t2, sets a second value (D−O) obtained by subtracting the offset O from the propagation delay time D to be equal to a value (t4−t3) obtained by subtracting the third time t3 from the fourth time t4, and calculates the propagation delay time D=((t2−t1)+(t4−t3))/2 by adding the first value (D+O) and the second value (D−O) and dividing both sides of the result by 2.

4. The system of claim 1, wherein an activation time period of the slave clock device ranges from the third time t3 to a fifth time t5 at which the slave clock device receives the time information response signal.

5. The system of claim 1, wherein the slave clock device is installed in a switching device, a router or a communication terminal.

6. A method for time synchronization on a network which includes a master clock device and a slave clock device, comprising:
activating the slave clock device when the slave clock device has to correct a time of the slave clock device;
receiving from the master clock device a time synchronization signal including information on a first time t1 at which the time synchronization signal is transferred;
storing, in the slave clock device, information on a second time t2 at which the time synchronization signal is received;
transferring a time information request signal to the master clock device, and storing, in the slave clock device, information on a third time t3 at which the time information request signal is transferred;
transferring to the slave clock device a time information response signal including information on a fourth time t4 at which the time information request signal is received; and
performing time synchronization with the master clock device using the information on the first to fourth times t1 to t4.

7. The method of claim 6, wherein the performing of time synchronization with the master clock device comprises:
setting a first value (D+O) obtained by adding a propagation delay time D and an offset O to be equal to a value (t2−t1) obtained by subtracting the first time t1 from the second time t2;
setting a second value (D−O) obtained by subtracting the offset O from the propagation delay time D to be equal to a value (t4−t3) obtained by subtracting the third time t3 from the fourth time t4; and
calculating the offset O=((t2−t1)−(t4−t3))/2 by subtracting the second value (D−O) from the first value (D+O) and dividing both sides of the result by 2, and incorporating the offset O into a time of the slave clock device to perform time synchronization with the master clock device.

8. The method of claim 6, wherein the performing of time synchronization with the master clock device comprises:
setting a first value (D+O) obtained by adding a propagation delay time D and an offset O to be equal to a value (t2−t1) obtained by subtracting the first time t1 from the second time t2;
setting a second value (D−O) obtained by subtracting the offset O from the propagation delay time D to be equal to a value (t4−t3) obtained by subtracting the third time t3 from the fourth time t4; and
calculating the propagation delay time D=((t2−t1)+(t4−t3))/2 by adding the first value (D+O) and the second value (D−O) and dividing both sides of the result by 2.
